(19) United States
(12) Patent Application Publication
(10) Pub. No.: US 2014/0265140 A1
(43) Pub. Date: Sep. 18, 2014

(54) DISSIMILAR RADIAL WALL OIL CONTROL RAILS

(71) Applicant: Mahle International GmbH, Stuttgart (DE)

(72) Inventor: Steven J. Sytsma, Muskegon, MI (US)

(73) Assignee: Mahle International GmbH, Stuttgart (DE)

(21) Appl. No.: 14/212,870

(22) Filed: Mar. 14, 2014

Related U.S. Application Data
(60) Provisional application No. 61/793,401, filed on Mar. 15, 2013.

(51) Int. Cl. F16J 9/20

(52) U.S. Cl. CPC F16J 9/20
USPC 277/310; 277/434

(57) ABSTRACT

Exemplary pistons and oil control ring assemblies are disclosed, along with methods of making and using the same. An exemplary piston assembly includes a main body defining an outer circumferentially disposed groove, and an oil control ring assembly selectively disposed within the outer circumferentially disposed groove. The oil control ring assembly may include upper and lower oil control rails selectively disposed within the piston groove, each having a respective seal surface configured to seal against a piston bore surface of an engine. The oil control ring assembly may further an expander selectively disposed in the groove. The expander may be configured to push the upper and lower oil control rails radially outward to contact the piston bore surface. The upper and lower oil control rings may define different radial widths.

### BACKGROUND

Piston ring seals are generally seated in a groove formed in the outer circumference of a piston and perform at least two functions to ensure efficient operation of the engine. First, during the power cycle, the ring seals prevent gases under high pressure from bypassing the piston. Thus, maximum driving force is applied to the piston. Second, on the return stroke, the ring seals prevent lubricants from entering the combustion chamber and being consumed. If the ring seals fail to perform efficiently, the engine will not develop the maximum power due to “blow-by” on the power cycle. Additionally, if the ring seals leak during the return stroke, lubricants will enter the combustion chamber, thereby reducing combustion efficiency and increasing air pollution by way of the exhaust cycle. Generally, the ring seal provides the interface between the piston and the cylinder wall. Accordingly, the general configuration of the ring seal at least partially determines the friction between the piston assembly and the surfaces of the engine bore during operation. Further, this frictional characteristic influences efficiency of the engine, such that reduced friction generally leads to increased fuel economy.

One known piston ring design includes two separate piston rings that contact the engine bore surface to provide a seal. An expander having lands for each of the two rings generally urges the rings outwardly against an associated cylinder bore surface. Generally, the tension of the rings must be high enough to prevent blow by of engine oil. Greater tension, however, increases friction and also reduces fuel efficiency.

Accordingly, there is a need for a piston ring design that balances these factors.

### BRIEF DESCRIPTION OF THE DRAWINGS

FIG. 1 is a perspective view of an exemplary piston assembly;

FIG. 2 is a fragmentary, sectional view of the piston assembly shown in FIG. 1; and

FIG. 3 is a process flow diagram for an exemplary process of making a piston ring assembly.

### DETAILED DESCRIPTION

Illustrative examples are described below, with reference to the drawings. Although the drawings represent the exemplary illustrations described herein, the drawings are not necessarily to scale and certain features may be exaggerated to better illustrate and explain an innovative aspect of an exemplary illustration. Further, the exemplary illustrations described herein are not intended to be exhaustive or otherwise limiting or restricting to the precise form and configuration shown in the drawings and disclosed in the following detailed description.

Reference in the specification to “an exemplary illustration”, an “example” or similar language means that a particular feature, structure, or characteristic described in connection with the exemplary approach is included in at least one illustration. The appearances of the phrase “in an illustration” or similar type language in various places in the specification are not necessarily all referring to the same illustration or example.

Exemplary illustrations are provided herein of a piston assembly and piston ring assembly that may be selectively disposed within an outer circumferentially disposed groove of a piston. An exemplary piston ring assembly may include upper and lower oil control rails that are selectively disposed within the piston groove. Each of the upper and lower oil control rails include respective upper and lower seal surfaces that are configured to seal against the piston bore surface of an engine. A radial width of the upper control rail may be different from a radial width of the lower control rail. The exemplary assembly may further include an expander that is selectively disposed in the groove of the piston. The expander is generally configured to push the upper and lower oil control rails radially outward to contact a piston bore surface.

Further exemplary illustrations are directed to a method of sealing a piston bore surface. An exemplary method of sealing a piston bore surface may include providing an upper and a lower control rail, each of which are selectively disposed within a piston groove of a piston. Each of the upper or lower oil control rails include respective upper and lower seal surfaces that are configured to seal against a piston bore surface of engine. The upper oil control rail defines a first radial width, while the lower oil control rail defines a second radial with. The first and second radial widths may be of a different magnitude. Accordingly, a torsion force may generally be applied to the expander due to the varied widths of the upper and lower oil control rails.

Turning now to FIG. 1, an exemplary illustration of a piston assembly 100 is shown. Piston assembly 100 may be received within bore (see FIG. 2) 200 of an engine block defining a bore surface 202. Piston assembly 100 includes a main body 102. The main body 102 includes two outer circumferentially disposed upper grooves 104a, 104b that receive upper piston rings 108a, 108b, respectively. Main body 102 also includes a second outer circumferentially disposed groove 106 receiving an oil control rail assembly 110. Although three grooves 104a, 104b, 106 are shown receiving respective piston rings 108a, 108b and oil control rail assembly 110, respectively, any number of grooves may be provided in piston main body 102 that is convenient.

Generally, exemplary piston ring assemblies may experience a lower amount of tension against an associated piston or surface due to generally mismatched radial widths of the upper and lower oil control rails. By comparison, previous approaches emphasize substantially equally sized radial width rails in order to maintain balance of the expander, but also increasing tension against the outer bore surface.

Nevertheless, this reduction in tension, and corresponding gain in fuel economy, has been accomplished without sacrificing oil consumption. More specifically, the difference in radial widths, which reduces tension overall of his ring assembly against the cylinder bore surface, also tends to apply a torsional force to the expander. The torsional force may generally facilitate sealing of the outer cylinder bore surface.

More specifically, referring now to FIG. 2, an exemplary illustration piston ring assembly 110 is described in further detail. An exemplary piston ring assembly such as the oil control rail assembly 110 illustrated in FIG. 2 may include a split expander 112, a split upper oil control ring 114, and a split lower oil control ring 118. Each of the oil control rings 114, 118 and the expander 112 may generally extend about an entire periphery of the piston main body 102 after installation. As shown in FIG. 2, upper oil control ring 114 is disposed above the expander 112 in an axial direction, i.e., in a direction parallel to the bore surface 202 and generally coinciding with the direction of travel of the piston during operation. The lower oil control ring 118 is disposed axially below the expander 112. The expander 112 is selectively disposed within groove 106 between the upper and lower oil control rings 114, 118.

The expander 112 is disposed with the groove 106 and is configured to generally push, engage or otherwise encourage the upper and lower oil control rings 114, 118 radially outward, thereby generally maintaining outer seal surfaces 120a, 120b of the rings 114, 118 against piston bore surface 202. The seal surfaces 120, by generally maintaining contact with piston bore surface 202, may thus generally prevent lubricants such as oil, e.g., from an engine crankcase, from escaping upwards into the combustion chamber. Further, the seal surfaces 120 may scrape lubricants from the bore surface 202, allowing the lubricant to return to the engine crankcase (not shown), e.g., via an annular passage about the piston main body 102 or through vents (not shown) leading into the interior of the piston main body 102. As shown in FIGS. 1 and 2, the seal surfaces 120 may be generally radiused. Alternatively, the seal surfaces 120 may be generally flat, and may be aligned parallel to the bore surface 202 or may be slightly misaligned with respect to the bore surface 202, as further described below.

Each of the oil control rings 114 and 118 generally define an outermost periphery that is disposed radially outwardly of the piston body 102 and the groove 106. The oil control rings 114, 118 may thus define an outer diameter D_{PR}, as best seen in FIG. 1. Further, this outer diameter is less than an outer diameter of the piston main body 102, represented in FIG. 1 as D_{P}. Thus, the only portions of the oil control rail assembly 110 that contact piston bore surface 202 are the seal surfaces 120a, 120b. Moreover, as will be described below in some cases one of the seal surfaces 120a, 120b may be out of contact with the bore surface 202 during operation. The rings 114, 118 may be relatively thin, such that the seal surfaces 120 define a small axial height, thus generally reducing the amount of friction between oil control ring assembly 110 and bore surface 202.

The rings 114, 118 may have different radial widths such that the expander 112 is misaligned or rotated slightly with respect to the groove 106. In one exemplary illustration, an upper oil control rail 114 has a larger radial width Wᵤ than the lower oil control rail 118, which has a smaller radial width W_{L}. Accordingly, a torsional force applied by the mismatched oil control rails 114, 118 may tend to rotate the expander 112 in a direction R, such that an upper outer corner 122 of the expander is urged radially inwardly with respect to the piston groove 106, such that the upper outer corner 122 of the expander is further away from the piston bore surface 202 than a lower outer corner 124 of the expander 112.

While the upper oil control rail 114 has a greater radial width W_{U} than the radial width W_{L} of the lower oil control rail 118 in the example shown in FIG. 2, and while the illustrated example has been found advantageous, in other exemplary approaches an upper control rail may have a smaller radial width than that of the lower oil control rail. In such alternative approaches, the torsional force on the expander would urge rotation of the expander 112 in the opposite direction, i.e., opposite to rotational direction R, such that the upper outer corner 122 of the expander 112 is closer to the bore surface 202 than the lower outer corner 124 of the expander 112.

As noted above, a torsional force applied to the expander 112 by the mismatched radial widths W_{U}, W_{L} of the rings 114, 118, respectively, will tend to urge the upper outer corner 122 away from the associated piston bore surface 202 and the lower outer corner 124 toward the associated piston bore surface 202. Moreover, the upper outer corner 122 of the expander 112 may generally push the upper oil control rail 114 upwards against an upper side 126 of the piston groove 106. The upper outer corner 122 of the expander 112 applies the upward axial force to the upper oil control rail 114 at a radial position disposed radially outwardly on the oil control rail 114. Accordingly, the axial upward force applied by the expander 112 to the rail 114 results in a different sealing effect as compare with traditional approaches where axial force is applied to a ring along an inside diameter of the ring. More specifically, the application of axial force to the rail 114 from a radially outer position on the expander 112, i.e., from the upper outer corner 122, may result in a more effective seal between the ring 114 and the upper surface 126 of the groove 106 than where axial force is applied to the ring 114 from a radially inner position, e.g., along an inside diameter of the ring 114. Accordingly, the additional pressure exerted by the expander 112 on the upper oil control rail 114 may further enhance sealing of the groove 106.

Turning now to FIG. 3, an exemplary process 300 is illustrated. Process 300 may begin at block 302, where an upper oil control rail is provided. For example, as described above an upper oil control ring 114 may be selectively disposed within a piston groove 106. Additionally, the ring may include a seal surface 120a configured to seal against a piston bore surface 202. The upper oil control rail 114 may also define a first radial width, e.g., width W_{U}.

Proceeding to block 304, a lower oil control rail may be provided. For example, as described above an oil control rail 118 may be selectively disposed within the piston groove 106 and may define a seal surface 120b configured to seal against a piston bore surface of an engine. The lower oil control rail 118 may define a second radial width W_{L}. The second radial width W_{L} may be different, e.g., in magnitude, from the first radial width W_{U} such that a torsional force is applied to the expander 112, as described further below.

Proceeding to block 306, an expander may be positioned between the upper and lower oil control rails. In one exemplary approach described above, the expander 112 is configured to push the upper and lower oil control rails 114, 118 radially outward to contact the piston bore surface 202. Moreover, as described above, where the second radial width W_{L} is less than the first radial width W_{U}, an upper corner 122 of the expander 112 may be urged further away from an associated bore surface 202 than a lower outer corner 124 of the expander 112. In this manner, an upper outer edge of the expander 112 is urged radially inward with respect to the outer circumferentially disposed groove 106. Additionally, a lower outer edge of the expander 112 may be urged radially outward with respect to the outer circumferentially disposed groove 106 by the different first and second radial widths. Torsional forces applied by the expander 112 may also urge the upper oil control ring 114 axially upward against an upper surface 126 of the piston groove 106, and may also urge the lower oil control ring 118 radially outwardly from the piston groove 106 such that a greater force is applied radially by the seal surface 120b against the bore surface 202. Process 300 may then terminate.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “the,” etc. should be read to recite one or more of the indicated elements unless a claim recites an explicit limitation to the contrary.

What is claimed is:

1. A piston ring assembly selectively disposed within an outer circumferentially disposed groove of a piston, comprising:
an upper oil control rail selectively disposed within the piston groove and including a seal surface configured to seal against a piston bore surface of an engine, the upper oil control rail defining a first radial width;
a lower oil control rail selectively disposed within the piston groove and including a seal surface configured to seal against a piston bore surface of an engine, the lower oil control rail defining a second radial width; and
an expander selectively disposed in the groove, the expander configured to push the upper and lower oil control rails radially outward to contact the piston bore surface;
wherein the first radial width is different from the second radial width.

2. The piston ring assembly of claim 1, wherein the different first and second radial widths are configured to force one of an upper outer corner and a lower outer corner of the expander radially inward with respect to the outer circumferentially disposed groove.

3. The piston ring assembly of claim 1, wherein the different first and second radial widths are configured to force one of an upper outer corner and a lower outer corner of the expander radially outward with respect to the outer circumferentially disposed groove.

4. The piston ring assembly of claim 1, wherein the different first and second radial widths are configured to apply a torsion to the expander, the torsion forcing an upper outer edge of the expander radially inward with respect to the outer circumferentially disposed groove.

5. The piston ring assembly of claim 1, wherein the different first and second radial widths are configured to apply a torsion to the expander, the torsion forcing a lower outer edge of the expander radially outward with respect to the outer circumferentially disposed groove.

6. The piston ring assembly of claim 1, wherein the first radial width is greater than the second radial width.

7. A piston assembly, comprising:
a main body defining an outer circumferentially disposed groove; and
an oil control ring assembly selectively disposed within the outer circumferentially disposed groove, the oil control ring assembly including:
an upper oil control rail selectively disposed within the piston groove and including a seal surface configured to seal against a piston bore surface of an engine, the upper oil control rail defining a first radial width;
a lower oil control rail selectively disposed within the piston groove and including a seal surface configured to seal against a piston bore surface of an engine, the lower oil control rail defining a second radial width; and
an expander selectively disposed in the groove, the expander configured to push the upper and lower oil control rails radially outward to contact the piston bore surface;
wherein the first radial width is different from the second radial width.

8. The piston assembly of claim 7, wherein the different first and second radial widths are configured to force one of an upper outer corner and a lower outer corner of the expander radially inward with respect to the outer circumferentially disposed groove.

9. The piston assembly of claim 7, wherein the different first and second radial widths are configured to force one of an upper outer corner and a lower outer corner of the expander radially outward with respect to the outer circumferentially disposed groove.

10. The piston assembly of claim 7, wherein the different first and second radial widths are configured to apply a torsion to the expander, the torsion forcing an upper outer edge of the expander radially inward with respect to the outer circumferentially disposed groove.

11. The piston assembly of claim 7, wherein the different first and second radial widths are configured to apply a torsion to the expander, the torsion forcing a lower outer edge of the expander radially outward with respect to the outer circumferentially disposed groove.

12. The piston assembly of claim 7, wherein the first radial width is greater than the second radial width.

13. A method of sealing a piston bore surface, comprising:
providing an upper oil control rail selectively disposed within the piston groove and including a seal surface configured to seal against a piston bore surface of an engine, the upper oil control rail defining a first radial width;
providing a lower oil control rail selectively disposed within the piston groove and including a seal surface configured to seal against a piston bore surface of an engine, the lower oil control rail defining a second radial width; and
positioning an expander between the upper and lower oil control rails, the expander configured to push the upper and lower oil control rails radially outward to contact the piston bore surface; and
establishing the first radial width as different from the second radial width such that a torsional force is applied to the expander.

14. The method of claim 13, further comprising forcing an upper outer edge of the expander radially inward with respect to the outer circumferentially disposed groove with the different first and second radial widths.

15. The method of claim 13, further comprising forcing a lower outer edge of the expander radially outward with respect to the outer circumferentially disposed groove with the different first and second radial widths.

16. The method of claim 13, further comprising applying a torsion to the expander with the different first and second radial widths, the torsion forcing an upper outer edge of the expander radially inward with respect to the outer circumferentially disposed groove.

17. The method of claim 13, further comprising applying a torsion to the expander with the different first and second radial widths, the torsion forcing a lower outer edge of the expander radially outward with respect to the outer circumferentially disposed groove.

18. The method of claim 13, further comprising establishing the first radial width as greater than the second radial width.

19. The method of claim 13, wherein the torsional force urges the upper oil control ring axially upward against an upper surface of the piston groove.

20. The method of claim 19, wherein the torsional force is applied from a radially outer corner of the expander to the upper oil control ring.
